(19) United States
(12) Patent Application Publication
(10) Pub. No.: US 2022/0018390 A1
(43) Pub. Date: Jan. 20, 2022

(54) Steering system with pivot bearing

(71) Applicant: Schaeffler Technologies AG & Co. KG, Herzogenaurach (DE)

(72) Inventors: Jürgen Gebhardt, Hagenbüchach (DE); Seryas Mohammad, Aurachtal (DE)

(73) Assignee: Schaeffler Technologies AG & Co. KG, Herzogenaurach (DE)

(21) Appl. No.: 17/295,082

(22) PCT Filed: Oct. 18, 2019
(86) PCT No.: PCT/DE2019/100911

§ 371 Date: May 19, 2021

(30) Foreign Application Priority Data
Nov. 26, 2018 (DE) 10 2018 129 662.2
Jul. 22, 2019 (DE) 10 2019 119 705.8

(51) Int. Cl. F16C 19/16; B62D 5/04; F16C 23/08; F16C 33/60; F16C 33/78

(52) U.S. Cl. CPC F16C 19/166; B62D 5/0454; F16C 23/084; F16C 2326/24; F16C 33/7846; B62D 5/0421; F16C 33/60

(57) ABSTRACT

A steering system for a motor vehicle has a worm gear set, comprising a worm wheel and a worm shaft, wherein the worm shaft is rotatably mounted at least one bearing point in a housing of the worm gear set by means of a pivot bearing. The pivot bearing has an increased load capacity compared to a pivot bearing with a single-row standard deep groove ball bearing. A pivot bearing for a steering system has an inner ring and an outer ring, wherein a plurality of rolling elements is arranged between the inner ring and the outer ring. One of the bearing rings is designed as a full ring and the other bearing ring as a split bearing ring, the split bearing ring having a first ring element and a second ring element.

### CROSS-REFERENCE TO RELATED APPLICATIONS

This application is the U.S. National Phase of PCT Appln. No. PCT/DE2019/100911 filed Oct. 18, 2019, which claims priority to DE 10 2018 129 662.2 filed Nov. 26, 2018 and to DE 10 2019 119 705.8 filed Jul. 22, 2019, the entire disclosures of which are incorporated by reference herein.

### TECHNICAL FIELD

The disclosure relates to a steering system for a motor vehicle with a pivot bearing.

### BACKGROUND

In modern motor vehicles, steering systems are used in which the steering force is reduced during steering movements by the driver by means of a corresponding steering force assistance. This can be done in a known manner by hydraulic servo-assisted steering or by electrical or electrohydraulically-assisted steering force. In addition, steering systems are known which generate a steering torque on the vehicle side to notify the driver of the motor vehicle of a recommended steering movement. In electrically-assisted steering systems, an electric drive motor is usually used, which acts on the steering shaft via a worm gear set to produce a correspondingly high steering torque for turning the vehicle wheels.

Solutions are known from the prior art in which the worm shaft is mounted on a side facing the drive shaft via a first rolling bearing in a housing which is designed as a pivot bearing and allows a certain tilting movement transversely to the axial direction of the worm shaft. The worm shaft is supported at the opposite end section thereof by means of a second rolling bearing, which is connected to a gear housing of the worm gear set via a preloading element which causes a preloading force on the worm shaft in the direction of the worm wheel. The worm shaft can thus tilt about the pivot bearing as required to achieve a substantially constant engagement of the toothing on the worm shaft with the worm wheel.

DE 10 2016 221 076 A1 discloses a steering system for a motor vehicle with a worm gear set, which comprises a worm shaft that interacts with a worm wheel. To optimize the engagement between the worm shaft and the worm wheel, it is provided that a rotary bearing can be tilted relative to the housing of the steering system. In this case, rubber-elastic elements are provided between the rotary bearing and the housing, which cause a radial and axial support of the rocker bearing in the housing. Further-more, a spring element is provided for generating an axial prestressing force.

The disadvantage of the known solutions, however, is that the load capacity of the pivot bearing is limited in relation to the available installation space so that high loads through misuse can lead to damage of the pivot bearing.

### SUMMARY

It is desirable to propose a steering system with a pivot bearing which, compared to known steering systems, has a higher load capacity with unchanged bearing installation space.

A steering system for a motor vehicle has a worm gear set having a worm wheel and a worm shaft, wherein the worm shaft is mounted rotatably on at least one bearing point by means of a pivot bearing in a housing of the worm gear set. The pivot bearing has an outer ring and a split inner ring having a first ring element and a second ring element. Such a structure makes it possible for the pivot bearing to have an increased load capacity or load rating compared to a pivot bearing with a single-row standard ball bearing. In this context, a standard deep groove ball bearing is to be understood as a ball bearing which has a one-piece inner ring and a one-piece outer ring, wherein ball races for the balls are formed on the bearing rings and wherein a plurality of balls is arranged between the inner ring and the outer ring, which are guided in the ball races on the bearing rings. Since, with one-piece bearing rings, the deep groove ball bearing is installed by inserting the inner ring into the outer ring, filling in the ball and then elastically deforming the outer ring, the number of balls and the shoulder height of the ball races on the bearing rings and the associated load capacity of the standard deep groove ball bearing are limited. Using this method, depending on the maximum possible elastic ring deformability, ball fill levels of up to approx. 60% of the available race gap in the circumferential direction are achieved. The pivot bearing according to the present disclosure can increase this degree of filling up to 100%, whereby the load ratings are increased accordingly compared to such a standard deep groove ball bearing in a pivot bearing so that the load capacity of the pivot bearing can be increased with the same installation space. A split inner ring simplifies the filling of rolling elements, in particular balls, into the pivot bearing. As a result, the rolling elements can be filled in before the split inner ring is closed, as a result of which more rolling elements or larger rolling elements can be filled in than with a rolling bearing of the same size with one-piece bearing rings.

Alternatively, a pivot bearing is also conceivable in which the pivot bearing has an inner ring and a split outer ring. As an alternative to a split inner ring, it is possible to use a split outer ring for the rolling bearing. A splittable outer ring also makes it possible to fill the rolling elements into the pivot bearing before the bearing ring is closed. As a result, more or larger rolling elements can also be used and the load capacity of the pivot bearing can be increased.

The shoulders on the split inner ring, which are outer in the axial direction, may have an increased shoulder height with a shoulder height factor greater than 0.2. A raised shoulder enables the pivot bearing to absorb greater forces in the axial direction, as a result of which the bearing load of the pivot bearing can be increased further. The split bearing ring enables correspondingly higher shoulders, since the balls are filled in before the bearing ring is closed and the closing does not take place via elastic deformation of the outer ring.

The pivot bearing may include a ball bearing which, compared to a single-row standard deep groove ball bearing of the same diameter, has a larger number of balls. A split bearing ring as an inner ring or outer ring can make it easier to fill the balls into the track of the pivot bearing. Furthermore, it is possible to fill more balls into the pivot bearing since the number of balls is not limited by the elasticity of a bearing ring. The load capacity of the pivot bearing can be increased by the additional balls, which reduces the risk of damage to the steering system when the load is increased.

Alternatively, the pivot bearing may include a ball bearing which, compared to a single-row standard ball bearing of the same diameter, has larger balls. The load capacity of the pivot bearing can also be increased by using larger balls. However, the use of larger balls assumes that at least one of the bearing rings is designed as a split bearing ring to fill the balls into the race between the bearing rings.

The steering system may have electrical steering assistance, which amplifies the steering forces or steering torques of the driver. The driver's steering forces can be increased by means of electrical steering assistance. Alternatively, hydraulic servo assistance for the steering forces is possible. However, electrical steering assistance offers the advantage that no additional operating fluid is required and the steering assistance can be performed more easily overall.

A steering system with an inner ring and an outer ring is proposed, wherein a plurality of rolling elements is arranged between the inner ring and the outer ring, one of the bearing rings being designed as a one-piece bearing ring and the other bearing ring as a split bearing ring, and the split bearing ring has a first ring element and a second ring element. A pivot bearing with a one-piece first bearing ring and a split second bearing ring can improve the steering force, the steering torque, and the load capacity in pivot bearings, in particular pivot bearings for mounting a worm shaft in a steering system, or increase the durability and reduce the risk of damage.

The shoulders on the split bearing ring may have an increased shoulder height with a shoulder height factor greater than 0.2 compared to a one-piece bearing ring. A higher shoulder height can improve the load capacity of the pivot bearing in the axial direction so that higher axial loads can be transmitted.

A race geometry may be designed as a four-point bearing with a pressure angle greater than 10°.

The various embodiments proposed herein may be advantageously combined, unless otherwise indicated in the individual case.

### BRIEF DESCRIPTION OF THE DRAWINGS

In the following, the steering system is explained in more detail by means of a preferred exemplary embodiment and the corresponding drawings. In the drawings:

FIG. 1 shows an exemplary embodiment of a steering system having a pivot bearing;

FIG. 2 shows a preferred exemplary embodiment of a pivot bearing for a steering system.

### DETAILED DESCRIPTION

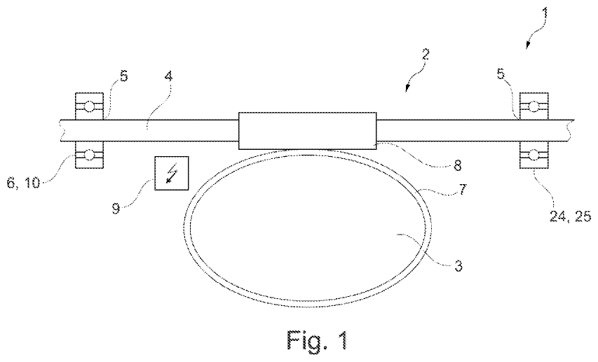

In FIG. 1 is shown an exemplary embodiment of a steering system 1 with a pivot bearing 6. The steering system has a worm gear set 2 with which a steering torque is transmitted from a worm shaft 4 to a worm wheel 3. For this purpose, a toothing 7 is formed on the worm wheel 3, which meshes with a toothed section 8 of the worm shaft 4. The worm shaft 4 is mounted rotatably on at least one bearing point 5, preferably on at least two bearing points 5, in a housing of the worm gear set 2. The steering system 1 is preferably designed as an electrically-assisted steering system 1. For this purpose, the steering system 1 comprises an electrical steering assistance system 9 with which the steering forces of the driver are supported to change the steering angle. The worm shaft 4 is mounted on the drive side by means of a pivot bearing 6. On the side facing away from the drive side, the worm shaft 5 is mounted by means of a second rolling bearing 24, which is designed as a floating bearing 25. The floating bearing 25 is pressed radially onto the worm shaft 5 by means of a preloading element so that the play of the toothing between the toothing section 8 on the worm shaft 5 and the toothing 7 on the worm wheel 3 is reduced to zero.

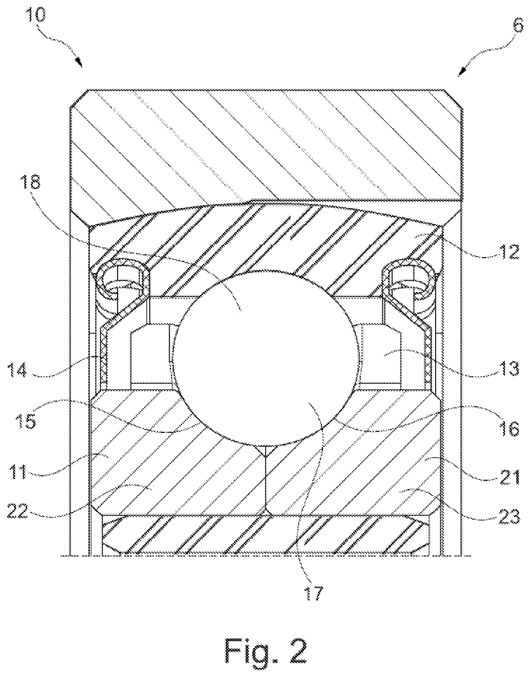

In FIG. 2, a pivot bearing 6 is shown as a special bearing 10 for such a steering system 1. The pivot bearing 6 has a split inner ring 21 which comprises a first ring element 22 and a second ring element 23. The pivot bearing 6 also has an outer ring 12, which is designed as a one-piece outer ring 12. Between the split inner ring 21 and the outer ring 12 there are a plurality of rolling elements 17, which in this exemplary embodiment are designed as balls 18. However, other known forms of rolling elements, in particular tapered rollers, are also possible. A race for the rolling elements 17 is formed on the outer ring 12 to enable the rolling elements to roll on the outer ring 12 with as little friction as possible. A first race 15 for the rolling elements is formed on the first ring element 22, and a second race 16 is formed on the second ring element 23 which guides the rolling elements 17 together with the race on the outer ring 12. The outer ring 12 of the pivot bearing 6 is tiltably received in a pivot ring of the pivot bearing 6, which enables a pivoting or tilting movement and thus an axial compensation in the pivot bearing 6. For this purpose, the outer ring 12 has a convex shape on the radially outer surface thereof and the pivot ring has a concave shape on the radially inner surface thereof so that a compensating movement is possible between the outer ring 12 and the pivot ring. The pivot bearing 6 also has a cage 13 which positions the rolling elements 17 with respect to one another. In addition, the pivot bearing 6 comprises sealing elements 14, which prevent dirt from penetrating into the region of the races 15, 16 of the rolling elements 17 and are intended to prevent lubricant from escaping from this region. Due to the split inner ring 21, the shoulders on the two ring elements 22, 23 can be made higher than a one-piece inner ring 11, whereby the load capacity of the pivot bearing increases. In addition, it is possible to use more balls and/or larger balls with the same diameter as a standard deep groove ball bearing since the inner ring 21 can be split for filling the balls 18 and the filling of the balls 18 is made easier in this way. In addition, the higher shoulders on the two ring elements 22, 23 of the split inner ring 21 allow greater axial loads to be transmitted. The assembly process for rolling bearings with a split inner ring differs as follows from an assembly process for a single-row rolling bearing with one-piece bearing rings 11, 12. The outer ring 12 and the first ring element 22 of the split inner ring 21 are filled with the rolling elements 17, the cage 13 is mounted, and only then is the second ring element 23 of the split inner ring 21 attached.

### LIST OF REFERENCE SYMBOLS

1 Steering system
2 Worm gear set
3 Worm wheel
4 Worm shaft
5 Bearing point
6 Pivot bearing
7 Toothing
8 Toothed section
9 Electric steering assistance
10 Special bearing
11 Inner ring
12 Outer ring
13 Cage
14 Sealing element
15 First race
16 Second race
17 Rolling element
18 Ball
21 Split inner ring
22 First ring element
23 Second ring element
24 Rolling bearing
25 Floating bearing

1. A steering system for a motor vehicle, the steering system comprising a worm wheel and a worm shaft, the worm shaft being mounted rotatably by a pivot bearing at at least one bearing point in a housing of the worm gear set, wherein the pivot bearing has an outer ring and a split inner ring, the split inner ring having a first ring element and a second ring element.

2. The steering system according to claim 1, wherein outer shoulders in an axial direction on the split inner ring or on the outer ring have a shoulder height with a shoulder height factor greater than 0.2.

3. The steering system according to claim 1, wherein the pivot bearing is a ball bearing having a larger number of balls than could be inserted into a ball bearing of the same diameter and no split ring.

4. The steering system according to claim 1, wherein the steering system has electrical steering assistance which amplifies the steering forces or steering torques.

5. A pivot bearing for a steering system having an inner ring and an outer ring, a plurality of rolling elements being arranged between the inner ring and the outer ring, wherein one of the inner and outer rings is a full ring and another of the inner and outer rings is a split bearing ring, wherein the split bearing ring has a first ring element and a second ring element.

6. The pivot bearing according to claim 5, wherein shoulders on the split inner ring have a shoulder height with a shoulder height factor greater than 0.2.

7. The pivot bearing according to claim 5, wherein a track geometry is designed as a four-point bearing with a pressure angle greater than 10°.

8. A steering system comprising:
a housing;
a worm wheel; and
a worm shaft engaging the worm wheel and pivotably mounted in the housing by a pivot bearing, the pivot bearing has an outer ring, a first inner ring, a second inner ring, and a plurality of balls retained between the outer ring, the first inner ring, and the second inner ring.

9. The steering system according to claim 8, wherein the first inner ring and the second inner ring have a shoulder height factor greater than 0.2.

10. The steering system according to claim 8, wherein the balls of the plurality of balls contact the outer ring, the first inner ring, and the second inner ring at a pressure angle greater than 10°.
